(19) United States
(12) Patent Application Publication
(10) Pub. No.: US 2016/0155198 A1
(43) Pub. Date: Jun. 2, 2016

(54) DISTRIBUTION APPARATUS, DISTRIBUTION METHOD, AND NON-TRANSITORY COMPUTER READABLE STORAGE MEDIUM

(71) Applicant: YAHOO JAPAN CORPORATION, Tokyo (JP)

(72) Inventors: Mari YOUKAWA, Tokyo (JP); Shuichi HIRATA, Tokyo (JP)

(21) Appl. No.: 14/953,219

(22) Filed: Nov. 27, 2015

(30) Foreign Application Priority Data
Dec. 2, 2014 (JP) 2014-244348

(51) Int. Cl. G06Q 40/04; H04L 29/08

(52) U.S. Cl. CPC G06Q 40/04; H04L 67/06

(57) ABSTRACT

A distribution apparatus according to an embodiment includes an accepting unit and a distribution unit. The accepting unit accepts, from a terminal device, a distribution request for content. The distribution unit distributes, to the terminal device, the content associated with investment information and information that is to be displayed on the terminal device together with the content and that indicates behaviors of viewers of information conveyed by the content with respect to the investment information. For example, the distribution unit distributes, as the information to be displayed on the terminal device together with the content, an index value that is generated from information on behaviors of the viewers with respect to the investment information and that is used to evaluate the investment information, to the terminal device.

### CROSS-REFERENCE TO RELATED APPLICATION(S)

The present application claims priority to and incorporates by reference the entire contents of Japanese Patent Application No. 2014-244348 filed in Japan on Dec. 2, 2014.

### BACKGROUND OF THE INVENTION

1. Field of the Invention

The present invention relates to a distribution apparatus, a distribution method, and a non-transitory computer readable storage medium having stored therein an information display program.

2. Description of the Related Art

In recent years, with the rapid growth of the Internet, it becomes increasingly popular to provide information on equity investments via a network. In general, investors obtain information, such as advice from experts, forecast information, and financial news.

Further, as an example of providing information on equity investments as described above, there has been known a technology for providing processed information based on news to a securities investor in order to enable the securities investor to promptly make a decision to select an issue to be purchased or sold.

However, in the conventional technology as described above, it is not always possible to promote investment behaviors of users. Specifically, in the conventional technology as described above, a securities investor as a user registers issues or keywords of interest in advance, and displays headlines of news articles related to the registered issues or keywords. That is, in the conventional technology as described above, only users who have adequate investment experiences can effectively acquire investment information, but it is difficult for users who have less investment experiences to effectively acquire and use investment information.

Furthermore, it is generally difficult for users who have less investment experiences to acquire information on investments, such as securities or equites, and determine investment behaviors based on the information. Therefore, the users are less likely to be motivated to try new investment behaviors. As described above, in the conventional technology, it is not always possible to promote the investment behaviors of users.

### SUMMARY OF THE INVENTION

It is an object of the present invention to at least partially solve the problems in the conventional technology.

A distribution apparatus according to the present application includes an accepting unit that accepts, from a terminal device, a distribution request for content, and a distribution unit that distributes, to the terminal device, the content associated with investment information, and information that is to be displayed on the terminal device together with the content and that indicates behaviors of viewers of information conveyed by the content with respect to the investment information, in accordance with the distribution request accepted by the accepting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a distribution and information display process according to an embodiment;

FIG. 2 is a diagram illustrating a configuration example of a distribution apparatus according to the embodiment;

FIG. 3 is a diagram illustrating an example of a news data storage unit according to the embodiment;

FIG. 4 is a diagram illustrating an example of a user information storage unit according to the embodiment;

FIG. 5 is a diagram illustrating a configuration example of a terminal device according to the embodiment;

FIG. 6 is a flowchart illustrating the flow of an acquisition process performed by the distribution apparatus according to the embodiment;

FIG. 7 is a flowchart illustrating the flow of a distribution process performed by the distribution apparatus according to the embodiment;

FIG. 8 is a flowchart illustrating the flow of an information display process performed by the terminal device according to the embodiment;

FIG. 9 is a diagram illustrating an example of an information display process according to a modification; and

FIG. 10 is a diagram illustrating an example of a hardware configuration of a computer that implements functions of the terminal device.

### DETAILED DESCRIPTION OF THE PREFERRED EMBODIMENTS

Hereinafter, modes (hereinafter, referred to as “embodiments”) for carrying out a distribution apparatus, a distribution method, and a non-transitory computer readable storage medium having stored therein an information display program according to the present application will be described in detail with reference to drawings. The distribution apparatus, the distribution method, and the non-transitory computer readable storage medium having stored therein information display program of the present application are not limited by the embodiments. In each of the embodiments below, the same components will be denoted by the same reference numerals and symbols, and the same explanation will be omitted.

1. Distribution and Information Display Process

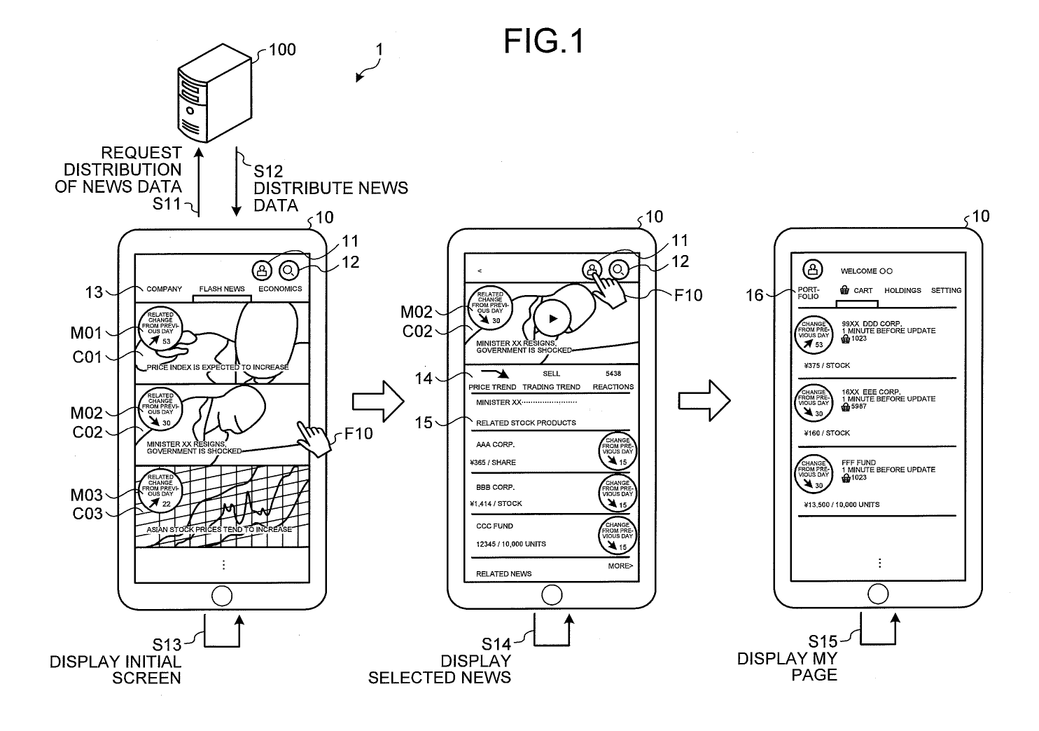

First, an example of a distribution and information display process according to an embodiment will be described with reference to FIG. 1. FIG. 1 is a diagram illustrating an example of the distribution and information display process according to the embodiment. In FIG. 1, a distribution system 1 will be described as an example to explain the distribution and information display process according to the embodiment of the present application. Specifically, in FIG. 1, a case will be described in which a distribution apparatus 100 included in the distribution system 1 performs a process of distributing a predetermined information content (for example, news data including a news article, a news video, and the like) in association with investment information (for example, a stock issue, a name of a fund such as an investment trust, and a stock price of each issue) to a terminal device 10, and the terminal device 10 performs a process of displaying the content and an index value that is about the investment information associated with the content and that is for evaluation of the investment information based on a behavior of a user who is a viewer of the content.

As illustrated in FIG. 1, the distribution system 1 includes the terminal device 10 and the distribution apparatus 100. The distribution apparatus 100 is communicably connected to the terminal device 10 via a communication network (for example, the Internet) (not illustrated). The number of the terminal devices 10 included in the distribution system 1 is not limited to the number in the example illustrated in FIG. 1. For example, the distribution system 1 may include a plurality of the terminal devices 10.

The terminal device 10 is an information processing apparatus used by a general user. Specifically, the terminal device 10 is used by a user to view a web page or to use an application installed in the terminal device 10. The terminal device 10 is, for example, a mobile terminal such as a smartphone, a tablet terminal, or a personal digital assistant (PDA), a desktop personal computer (PC), or a notebook PC.

The distribution apparatus 100 is a server device that accepts, from the terminal device 10, a distribution request for content, and distributes the content according to the request to the terminal device 10. First, the distribution apparatus 100 acquires news data from a predetermined news data provider. Subsequently, the distribution apparatus 100 extracts, based on the acquired news data, investment information to be associated with the news data. Then, the distribution apparatus 100 distributes the news data and the investment information in an associated manner to the terminal device 10. The distribution process and the information display process performed by the distribution system 1 will be described in accordance with the flow in FIG. 1.

In the example illustrated in FIG. 1, the terminal device 10 transmits, to the distribution apparatus 100, a request for distribution of news data (Step S11). The terminal device 10 transmits the request to the distribution apparatus 100 in accordance with an information display application (hereinafter, may be simply referred to as an “application”) installed in advance. For example, upon activation of the application, the terminal device 10 transmits the request in order to acquire a news article to be displayed on an initial screen of the application.

The distribution apparatus 100 distributes news data according to the request accepted from the terminal device (Step S12). At this time, the distribution apparatus 100 distributes the news data and investment information related to the news data in an associated manner. Therefore, a user who views the news article contained in the distributed news data can obtain the news article and an issue of an investment product or the like related to the news.

The investment information related to the news data is, for example, a stock issue or the like extracted from text of the news article contained in the news data. Specifically, the distribution apparatus 100 performs a morphological analysis on text data of the news article, and extracts a stock issue estimated to have high relevance to the news article. The stock issue estimated to have high relevance to the news article is an issue to be extracted based on the news article when, for example, the news article contains a name of a board member of a company indicating the issue, contains a name of a company with a capital relationship, or contains information indicating an increase or a decrease in business performance of a related industry. If the news data distributed by the distribution apparatus 100 is financial news data, the news article may include an issue and an issue code (for example, a four-digit number for identifying the issue). In this case, the distribution apparatus 100 may directly associate the issue indicated by the issue code as an issue that has high relevance to the news data.

The terminal device 10 displays the distributed news data on the initial screen of the application (Step S13). The terminal device 10 displays information displayed on the application onto an output unit (for example, on a touch panel) provided in the terminal device 10.

As illustrated in FIG. 1, a display screen of the application that runs in the terminal device 10 includes a my page icon 11, a search icon 12, a news genre selection icon 13, pieces of news data C01 to C03, and investment information displays M01 to M03. For example, the user can give an instruction to the application by touching each of the icons displayed on the touch panel with a finger F10.

As illustrated in FIG. 1, the terminal device 10 displays the news data C01 and displays the investment information display M01 on the news data C01 in an overlapping manner. In the initial screen of the application, the news data C01 is displayed with a headline of a news article and an image representing the news. The investment information display M01 is a display for displaying an index value generated based on actual behaviors of users as viewers of the news data C01 with respect to investment information associated with the news data C01, and is information indicating evaluation of the investment information by the users. Incidentally, viewing of the news data C01 in this case need not be user's viewing of the same content as the news data C01 that is content distributed by the distribution apparatus 100. Specifically, the content may be displayed in various modes depending on the terminal device 10 for which distribution is performed. For example, communication information conveyed by the news data C01 as an example of the content may be a news article, a news related image, a news video, or the like. That is, the viewer of the news data C01 is not necessarily limited to a user who views the news in the same viewing mode and the same display mode, but includes any user who views the communication information conveyed by the news data C01.

In the example in FIG. 1, the investment information display M01 is displayed with “related change from previous day”, a value of “53”, and an “upward arrow”. This indicates that the investment information display M01 is comparative information between the previous day and the current time with respect to behaviors of users in response to the investment information associated with the news data C01. In the example in FIG. 1, the investment information display M01 indicates that the number of registrations in a watch list by users for each issue contained in the investment information associated with the news data C01 is increased by “53” as compared to the previous day. Registration in the watch list means that a user who has viewed news registers, as an object to be monitored, an issue associated with the news in a predetermined list in order to check a movement in the stock price of the issue. By registering the issue in the watch list, the user can check the price movement of the issue in a predetermined screen in the application. On the application, the number of registrations in the watch list is indicated by a value of a shopping cart icon that is displayed near an issue. Therefore, as expression on the application, “registration in the watch list” may be described as “addition to a cart”. In other words, registration in the watch list is a user's behavior of setting each issue as a candidate trade object. Furthermore, deletion from the watch list is a user's behavior of excluding each issue from candidate trade objects.

As described above, when displaying the news data C01 on the initial screen of the application, the terminal device 10 displays not only the headline of the news article and the news image, but also the investment information display M01 simultaneously. Therefore, the user can simultaneously check the news article of interest and behaviors (registrations in the watch list) of other users with respect to the issue associated with the news. In other words, the user can check a degree of attention indicating how much attention is given by other users who have viewed the news to the investment information associated with the news.

Subsequently, the terminal device 10 displays news that is selected by the user by selecting an area displaying each piece of news data (Step S14). Specifically, as illustrated in FIG. 1, when the user touches an area displaying the news data C02 with the finger F10, the terminal device 10 displays a screen indicating details of the news data C02.

The terminal device 10 displays, as the details of the news data C02, trend information 14 indicating a trend of a price movement of an issue related to the news data C02, a trading trend of other users, the number of reactions of other users in a social networking service (SNS), and the like. Furthermore, the terminal device 10 displays a related stock product list 15. The related stock product list 15 is investment information associated with the news data C02 by the distribution apparatus 100. For example, in FIG. 1, “AAA Corp.”, “BBB Corp.”, and “CCC fund” are associated with the news data C02. Furthermore, in the initial screen of the application, the investment information display M02 indicates, by the index value of “related change from previous day”, the total number of changes in watch lists for a plurality of issues associated with the news data C02. However, as illustrated in FIG. 1, in the screen for displaying the details of the news data C02, the terminal device 10 may display the number of changes in the watch list for an individual issue, such as “AAA Corp.”, by an index value of “change from previous day”. In this manner, the terminal device 10 can provide the degree of attention, such as reactions of users, and related investment information to a user even in each piece of news data, such as the news data C02.

When the user selects an area displaying the my page icon 11, the terminal device 10 displays an application screen personalized for each user (hereinafter, referred to as a “my page”) (Step S15). As illustrated in FIG. 1, the terminal device 10 displays, in the my page of a user “∘∘”, a user item 16 including items such as “portfolio” and “cart”.

Incidentally, issues displayed in the item of “cart” indicate issues registered in a watch list of the user “∘∘”. In FIG. 1, the user “∘∘” has registered “DDD Corp.”, “EEE Corp.”, and “FFF fund” in the watch list. The terminal device 10 can display, even in the my page, the index value indicating the number of changes in registrations of each issue in the watch list or indicating the number of registrations in the watch list by users, together with the issue. Therefore, the user can recognize the degree of attention of other users on the issue that the user has registered in the watch list, and can recognize a change in the degree of attention.

As described above, the distribution apparatus 100 according to the embodiment accepts, from the terminal device 10, a distribution request for news data associated with the investment information. Then, the distribution apparatus 100 distributes, to the terminal device 10, the news data and information that indicates actual behaviors of users with respect to the investment information associated with the news data and that is to be displayed on the terminal device 10 together with the news data, in accordance with the accepted distribution request.

Furthermore, the terminal device 10 according to the embodiment accepts the news data distributed from the distribution apparatus 100. Then, the terminal device 10 displays the accepted news data and the information on the actual behaviors of the users as the viewers of the news article with respect to the investment information associated with the news data.

Specifically, the distribution apparatus 100 according to the embodiment distributes the news data, issues related to the news data, and information on actual behaviors of users with respect to the issues, in conjunction with an application that runs on the terminal device 10. Then, the terminal device 10 displays a news article and an index value that is generated based on behaviors of the users and that is an index value clearly indicating trends, interests, or concerns of other users with respect to the issues related to the news data. Therefore, the user using the application can view the news article and recognize the issues related to the news article. Furthermore, the user can recognize reactions of other users against the issues related to the news article that the user is viewing. Therefore, for example, even a user who is not familiar with investment or a beginner in investment can recognize issues related to news or investment trends of the issues by viewing news articles. Furthermore, in general, news has high topicality, so that the user can obtain an index to determine a timing, such as a timing to purchase or sell an issue, by obtaining the investment trend of the issue together with the news. Consequently, according to the distribution apparatus 100 and the terminal device 10 of the embodiment, it is possible to promote the investment behavior of the user.

2. Configuration of Distribution Apparatus

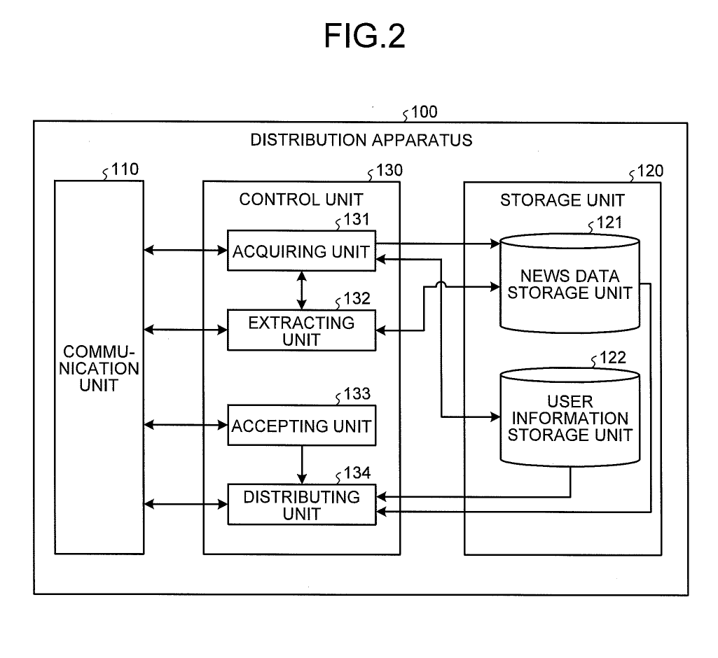

A configuration of the distribution apparatus 100 according to the embodiment will be described below with reference to FIG. 2. FIG. 2 is a diagram illustrating a configuration example of the distribution apparatus 100 according to the embodiment. As illustrated in FIG. 2, the distribution apparatus 100 includes a communication unit 110, a storage unit 120, and a control unit 130. The distribution apparatus 100 may include an input unit (for example, a keyboard, a mouse, or the like) that accepts various types of operation from an administrator or the like using the distribution apparatus 100, or an output unit (for example, a liquid crystal display or the like) that outputs various types of information.

Communication Unit 110

The communication unit 110 is implemented by, for example, a network interface card (NIC) or the like. The communication unit 110 is connected to a communication network by wire or wireless, and performs transmission and reception of information with the terminal device 10 via the communication network.

Storage Unit 120

The storage unit 120 is implemented by, for example, a semiconductor memory element, such as a random access memory (RAM) or a flash memory, or a storage device, such as a hard disk or an optical disk. The storage unit 120 according to the embodiment includes a news data storage unit 121 and a user information storage unit 122. Each of the storage units will be described below in sequence.

News Data Storage Unit 121

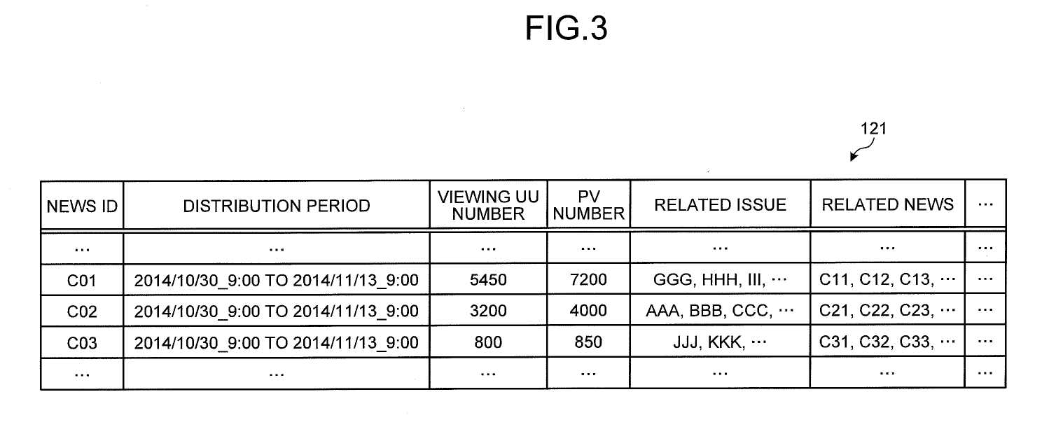

The news data storage unit 121 stores therein information on news data submitted from an external news data provider. The news data storage unit 121 stores therein information on a related issue extracted from the submitted news data. FIG. 3 illustrates an example of the news data storage unit 121 according to the embodiment. As illustrated in FIG. 3, the news data storage unit 121 contains items of “news ID”, “distribution period”, “viewing UU number”, “PV number”, “related issue”, and “related news”.

The “news ID” indicates identification information for identifying news data submitted to the distribution apparatus 100. The “distribution period” indicates a distribution period of the news data. As for news for which the distribution period has expired, the news data may become unavailable or a link to the news may be disabled.

The “viewing UU number” represents a value indicating how many unique users (UU) have viewed the news during the distribution period. The “PV number” represents a value indicating how many times the news article has been viewed during the distribution period. In FIG. 3, an example is illustrated in which the news data storage unit 121 stores therein the viewing UU number and the PV number at the current moment during the distribution period. However, as for the viewing UU number and the PV number, values in a predetermined period may be stored. For example, the news data storage unit 121 may store therein the viewing UU number and the PV number in one day on “Oct. 30, 2014”.

The “related issue” indicates an issue that is extracted by the distribution apparatus 100 as an issue related to the news data. The “related news” indicates news data related to the news data. For example, the related news is news expected to have high relevance, and may be news about topics in the same industry, latest news viewed by a user who has viewed certain news, or the like. The related news may be set by the distribution apparatus 100 or may be set by a news data provider.

Specifically, in FIG. 3, as an example of the news data, news data identified by a news ID of “C01” is news data in which the distribution period is “2014/10/30/9:00 to 2014/11/13/9:00”, the viewing UU number at the current moment is “5450” users, the PV number at the current moment is “7200” views, the related issues are “GGG, HHH, III”, and pieces of the related news are “C11, C12, C13”.

Incidentally, although not illustrated in FIG. 3, the news data stored in the news data storage unit 121 includes text data as a news article, image data and video data related to the news article, and the like.

User Information Storage Unit 122

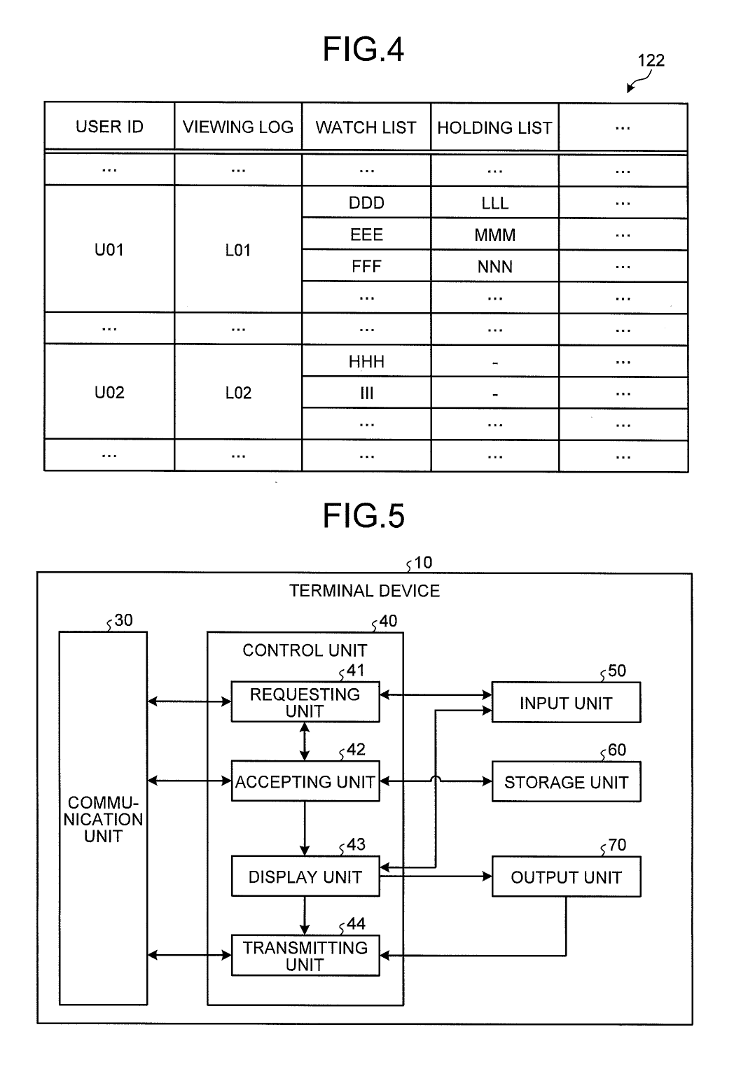

The user information storage unit 122 stores therein information on a user who has viewed news data or who has performed a behavior with respect to the issue related to the news data. FIG. 4 illustrates an example of the user information storage unit 122 according to the embodiment. As illustrated in FIG. 4, the user information storage unit 122 stores therein items of “user ID”, “viewing log”, “watch list”, and “holding list”.

The “user ID” is identification information for identifying a user. The “viewing log” indicates a user's behavior history of viewing news or the like on the network. For example, the viewing log is a data file containing an access log or the like obtained when the user views news by using an application or a web browser.

The “watch list” indicates issues that the user has registered in a watch list. The “holding list” indicates issues currently held by the user. When the user has not register an issue in the watch list or does not hold any issue, these items are blank.

Specifically, in FIG. 4, as an example of user information, a user identified by a user ID of “U01” has a viewing history as indicated by a viewing log of “L01”, has registered “DDD, EEE, FFF” in the watch list, and currently holds issues of “LLL, MMM, NNN”.

The user information as described above is stored in the user information storage unit 122 when the distribution apparatus 100 acquires information on a user's behavior or the like transmitted from the terminal device 10 according to operation of an application. Furthermore, while an example is illustrated in FIG. 4, in which names of issues are stored in the watch list and the holding list, issue codes (which are generally represented by four-digit numbers) may be stored as the issues.

Control Unit 130

The control unit 130 is implemented by, for example, executing various programs (corresponding to an example of a search program) stored in an internal storage device of the distribution apparatus 100 by a central processing unit (CPU), a micro processing unit (MPU), or the like by using a RAM as a work area. Alternatively, the control unit 130 may be implemented by, for example, an integrated circuit, such as an application specific integrated circuit (ASIC) or a field programmable gate array (FPGA).

As illustrated in FIG. 2, the control unit 130 according to the embodiment includes an acquiring unit 131, an extracting unit 132, an accepting unit 133, and a distribution unit 134, and implements or executes functions and operations of information processing as described below. Incidentally, the internal configuration of the control unit 130 is not limited to the configuration as illustrated in FIG. 2, and any other configuration that performs the information processing as described below is applicable. Furthermore, a connection relation between processing units of the control unit 130 is not limited to the connection relation as illustrated in FIG. 2, and any other connection relation is applicable.

Acquiring Unit 131

The acquiring unit 131 accepts submission of news data, and acquires news data contained in the accepted news article. Specifically, the acquiring unit 131 according to the embodiment acquires news data from a news data provider or the like via a predetermined news data server managed by each news data provider. The acquiring unit 131 stores the acquired news data in the news data storage unit 121.

Furthermore, the acquiring unit 131 acquires user information transmitted from the terminal device 10. Specifically, the acquiring unit 131 acquires information on a user's behavior of viewing news, registering an issue in the watch list, or purchasing or selling an issue, in an application that runs on the terminal device 10. That is, the distribution apparatus 100 acquires information on a user's behavior that is appropriately transmitted from the terminal device 10 in accordance with operation of the application that runs on the terminal device 10. The distribution apparatus 100 stores the acquired information in the news data storage unit 121 or the user information storage unit 122.

Extracting Unit 132

The extracting unit 132 extracts an issue to be associated with the news data on the basis of the news data acquired by the acquiring unit 131. Specifically, the extracting unit 132 according to the embodiment extracts, from text data contained in the news data acquired by the acquiring unit 131, an issue, an issue code, an issue that tends to occur in conjunction with a predetermined keyword, or the like.

For example, the extracting unit 132 acquires information on a keyword that is likely to be searched for together with the issue in a general search site or the like. If the acquired news data contains the keyword, the extracting unit 132 extracts, as the issue to be associated with the news data, an issue that tends to occur in conjunction with the keyword. Furthermore, if the news data contains a name of a public board member for a company and if the company has issued a stock, the extracting unit 132 may extract, as a related issue, an issue corresponding to the company.

Then, the extracting unit 132 stores the issue extracted from the news data and the news data in the news data storage unit 121 in an associated manner. In this case, the extracting unit 132 identifies the news data based on the news ID, and updates the news data by overwriting the news data with the related issue. The extracting unit 132 can appropriately perform the update process as described above. Therefore, the extracting unit 132 can extract the related issue in line with current events, and store the related issue in association with the news data.

Accepting Unit 133

The accepting unit 133 accepts, from the terminal device 10, a request for distribution of news data. For example, when the terminal device 10 activates an application, the accepting unit 133 according to the embodiment accepts a distribution request for news data to be displayed on an operation screen of the application.

Distribution Unit 134

The distribution unit 134 distributes a predetermined content according to the request accepted by the accepting unit 133. Specifically, in accordance with the distribution request accepted by the accepting unit 133, the distribution unit 134 according to the embodiment distributes, to the terminal device 10, news data associated with investment information, and information that is to be displayed on the terminal device 10 together with the news data and that indicates behaviors of users as viewers of communication information conveyed by the news data with respect to the investment information. In this case, for example, the distribution unit 134 may cooperate with an external server or the like that handles equity information or the like, and distribute a current status of each issue contained in the investment information (for example, a price movement or a trading status at the time of the distribution process) to the user.

Furthermore, the distribution unit 134 distributes, as information to be displayed on the terminal device 10 together with the news data, an index value that is generated from the information on behaviors of users with respect to the investment information associated with the news data and that is used to evaluate the investment information, to the terminal device 10. For example, the distribution unit 134 distributes, as the index value, information on the number of pieces of information on behaviors of users with respect to the investment information associated with the news data.

Specifically, the distribution unit 134 distributes, as the information on behaviors of users with respect to the investment information associated with the news data, at least one of information on setting of each issue as a candidate trade object by the users and information on exclusion of each issue from candidate trade objects by the users. In other words, the distribution unit 134 distributes information on registrations of each issue in the watch list by the users or information on deletions of each issue from the watch list by the users. That is, the distribution unit 134 distributes, as the index value, information on the number of registrations in the watch list by users for each issue associated with the news data. In this case, the terminal device 10 displays, as an investment information display corresponding to the news data, the number of users who have registered each issue in the watch list, together with the news article.

The distribution unit 134 may employ, as the index value to be distributed to the terminal device 10, a value indicated by a ratio between the number of registrations in the watch list by the users for each issue associated with the news data and the number of unique users who have viewed a news article contained in the news data. For example, the distribution unit 134 may employ, as the index value, a value obtained by dividing the number of registrations in the watch list by the number of the unique users, or a value obtained by dividing a sum of the number of trades of an issue and the number of registrations in the watch list during a predetermined period by the number of the unique users. Therefore, the user who views the news article by using the terminal device 10 can obtain information on how many users have viewed the news article and how many users among these users have registered the issue related to the news article in the watch list.

Moreover, the distribution unit 134 may distribute, as the information on behaviors of users with respect to the investment information associated with the news data, information other than the information on the number of registrations in the watch list and the number of deletions from the watch list. For example, the distribution unit 134 may distribute the number of users who have viewed a predetermined news article during a predetermined period, the number of views of the predetermined news article during a predetermined period, a value of a change in the number of users who have viewed the predetermined news article during a predetermined period, the number of transmissions of reactions of users against the predetermined news article or investment information associated with news data (for example, transmissions of comments on the network or transmissions of tweets on an SNS), the number of users who have viewed a news article related to the predetermined news article, or an average viewing time of the predetermined news article (for example, an average time of viewing content by all of users or an average time of spending in a web page displaying the content). The information on behaviors of users as described above may be acquired from an external web server or may be acquired by receiving information transmitted by a transmitting unit 44 of the terminal device 10.

3. Configuration of Terminal Device

A configuration of the terminal device 10 according to the embodiment will be described below with reference to FIG. 5. FIG. 5 is a diagram illustrating a configuration example of the terminal device 10 according to the embodiment. As illustrated in FIG. 5, the terminal device 10 includes a communication unit 30, a control unit 40, an input unit 50, a storage unit 60, and an output unit 70.

The communication unit 30 is implemented by, for example, a NIC or the like. The communication unit 30 is connected to a communication network by wire or wireless, and performs transmission and reception of information with the distribution apparatus 100 or an external server device that provides stock prices or stock information.

The input unit 50 is an input device that accepts various types of operation from a user. For example, the input unit 50 is implemented by a keyboard, a mouse, an operation key, or the like. The output unit 70 is a display device that displays various types of information. For example, the output unit 70 is implemented by a liquid crystal display or the like. If a touch panel is employed in the terminal device 10, the input unit 50 and the output unit 70 are integrated with each other.

The storage unit 60 is implemented by, for example, a semiconductor memory element, such as a RAM or a flash memory, or a storage device, such as a hard disk or an optical disk. The storage unit 60 stores therein, for example, news data and user information distributed from the distribution apparatus 100.

Control Unit 40

The control unit 40 is implemented by, for example, executing various programs (corresponding to an example of an information display program) stored in an internal storage device of the terminal device 10 by a CPU, an MPU, or the like by using a RAM as a work area. For example, the various programs correspond to programs of the information display application according to the embodiment. Alternatively, the control unit 40 may be implemented by, for example, an integrated circuit, such as an ASIC or an FPGA.

As illustrated in FIG. 5, the control unit 40 includes a requesting unit 41, an accepting unit 42, a display unit 43, and the transmitting unit 44, and implements or executes functions and operations of information processing as described below. Incidentally, the internal configuration of the control unit 40 is not limited to the configuration as illustrated in FIG. 5, and any other configuration that performs the information processing as described below is applicable. Furthermore, a connection relation between processing units of the control unit 40 is not limited to the connection relation as illustrated in FIG. 5, and any other connection relation is applicable.

Requesting Unit 41

The requesting unit 41 requests the distribution apparatus 100 to distribute content, such as news data, in accordance with user operation accepted via the input unit 50 or a program automatically executed in the terminal device 10. For example, the requesting unit 41 requests the distribution apparatus 100 to distribute news data to be displayed on a screen while an application is activated.

Accepting Unit 42

The accepting unit 42 accepts various types of information via the communication network. Specifically, the accepting unit 42 according to the embodiment accepts news data distributed from the distribution apparatus 100 in response to the request executed by the requesting unit 41.

Furthermore, the accepting unit 42 may accept information to be a basis for display on the output unit 70 by the display unit 43 in a process executed by the application as will be described later. For example, the accepting unit 42 accepts, from a predetermined server device, issue information, such as a stock price, at the current moment with respect to an issue associated with the acquired news data. Therefore, the accepting unit 42 can provide accurate information at the current moment when the user views the issue information by using the application.

Moreover, the accepting unit 42 may accept information from anything other than the distribution apparatus 100 and the server device that provides the issue information. For example, the accepting unit 42 accepts user information on an SNS site from a web server that provides an SNS service or the like. Specifically, the accepting unit 42 accepts and acquires, from an SNS site or a news site that has posted a news article corresponding to the accepted news data, behavior histories of users in the site (transmissions of information messages to other users, follows, or the number of tweets). The accepting unit 42 may acquire reactions of users against an issue associated with the news data, in addition to reactions against the news data. The above-described information may be used in a process executed by the display unit 43 to be described later. The accepting unit 42 stores the acquired information in the storage unit 60.

Display Unit 43

The display unit 43 displays various contents. Specifically, the display unit 43 according to the embodiment displays news data accepted by the accepting unit 42 and the information on behaviors of users with respect to the investment information associated with the news data. For example, the display unit 43 displays, on the output unit 70, news data, investment information associated with the news data, and a predetermined index value generated from behavior histories of users who have viewed the news.

For example, when the news data C01 illustrated in FIG. 1 is acquired, the display unit 43 displays the investment information display M01 indicating an index value corresponding to the news data C01. In the example illustrated in FIG. 1, the display unit 43 acquires information distributed from the distribution apparatus 100 with respect to the investment information associated with the news data C01, that is, acquires the number of users who have registered each issue in the watch list. Furthermore, the display unit 43 compares the acquired number of users with the number of users who have registered each issue associated with the news data C01 in the watch list on the previous day, and counts the value to be displayed as a related change from the previous day. Then, the display unit 43 displays the investment information display M01 containing the news data C01, the number indicating a change in the value relative to the previous day, and an arrow indicating whether the value has increased or decreased.

Furthermore, if the user requests to obtain detailed information contained in the news data, the display unit 43 further displays information on the news data. For example, as illustrated in FIG. 1, when the user selects the news data C02 in the initial screen of the application, the display unit 43 newly displays a screen in which details of the news data C02 are provided. In this screen, the display unit 43 displays, in addition to an image and a headline contained in the news data C02, a news article describing contents of the news, reactions of users who have viewed the news article provided by the news data C02, or information on behaviors of users with respect to an issue associated with the news data C02.

In the information display process as described above, the display unit 43 may display information that is acquired in advance by the accepting unit 42, or may display information that is acquired every time information is displayed. Therefore, the display unit 43 can provide a user with information in line with current events. Furthermore, while an example has been described above in which the display unit 43 displays the investment information display M01 based on information distributed from the distribution apparatus 100, the display unit 43 may perform a process of generating the investment information display M01 based on information on behaviors of users distributed from the distribution apparatus 100. In this case, the display unit 43 generates, as a part of a process performed by the application, the investment information display M01 based on the information distributed from the distribution apparatus 100 or based on the information accepted by the accepting unit 42, and displays the investment information display M01 together with the news data C01.

Transmitting Unit 44

The transmitting unit 44 transmits predetermined information. Specifically, the transmitting unit 44 according to the embodiment transmits information on a user who has viewed news data by an application to the distribution apparatus 100. For example, the transmitting unit 44 transmits information for identifying a user who has viewed news data or a viewing log indicating the number of views of the news data to the distribution apparatus 100.

Furthermore, the transmitting unit 44 transmits information on a behavior of a user with respect to an issue associated with the news data. For example, the transmitting unit 44 transmits a user's behavior history, such as a user's behavior of registering the issue associated with the news data in the watch list, a user's behavior of exclusion from the watch list, and a user's behavior of actually purchasing or selling an investment product.

4-1. Processing Flow (1)

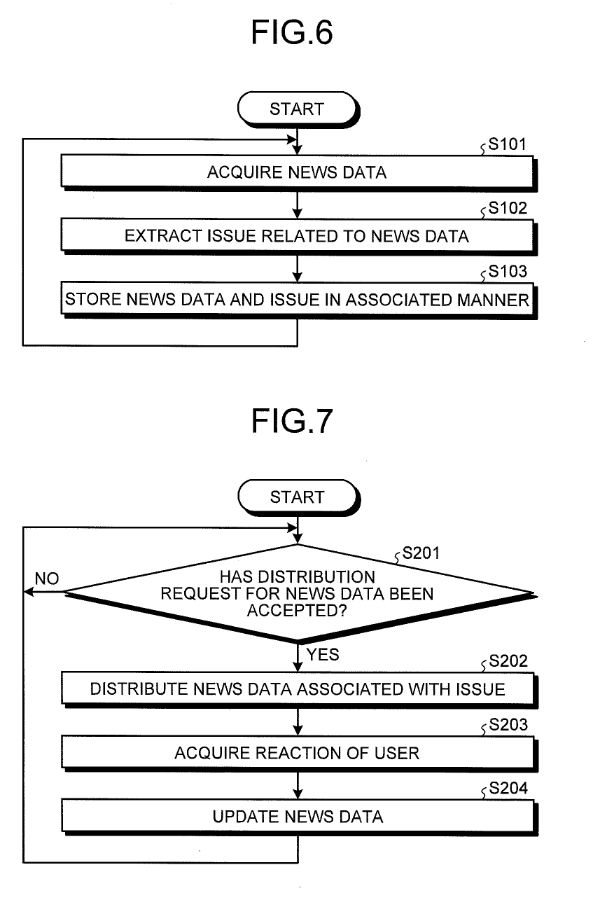

With reference to FIG. 6 and FIG. 7, the flow of processes performed by the distribution apparatus 100 according to the embodiment will be described. FIG. 6 is a flowchart illustrating the flow of an acquisition process performed by the distribution apparatus 100 according to the embodiment.

As illustrated in FIG. 6, the acquiring unit 131 of the distribution apparatus 100 acquires news data from a predetermined news data server (Step S101). The extracting unit 132 extracts an issue related to the news data based on the acquired news data (Step S102).

The extracting unit 132 stores the news data and the issue in the news data storage unit 121 in an associated manner (Step S103). The distribution apparatus 100 repeats the above process and accumulates pieces of news data and issues or the like extracted from the news data in the news data storage unit 121.

The flow of a distribution process performed by the distribution apparatus 100 according to the embodiment will be described below with reference to FIG. 7. FIG. 7 is a flowchart illustrating the flow of the distribution process performed by the distribution apparatus 100 according to the embodiment.

As illustrated in FIG. 7, the accepting unit 133 of the distribution apparatus 100 determines whether a distribution request for news data has been accepted from the terminal device 10 (Step S201). If the accepting unit 133 has not accepted the distribution request (NO at Step S201), the accepting unit 133 waits until the distribution request is accepted.

In contrast, if the accepting unit 133 has accepted the distribution request (YES at Step S201), the accepting unit 133 sends the accepted distribution request to the distribution unit 134.

Subsequently, the distribution unit 134 distributes news data associated with the issue to the terminal device 10 in response to the request accepted by the accepting unit 133 (Step S202). Thereafter, the acquiring unit 131 of the distribution apparatus 100 acquires a reaction of the user with respect to the distributed news data (Step S203).

Then, the acquiring unit 131 updates the news data with respect to information corresponding to the news data distributed by the distribution unit 134 (Step S204). For example, the acquiring unit 131 updates the viewing UU number or the PV number with respect to the news data, as needed. The distribution apparatus 100 repeats the process as described above, to thereby accumulate pieces of updated news data in the news data storage unit 121 and accumulate pieces of user information on users who have viewed the news data in the user information storage unit 122.

4-2. Processing Flow (2)

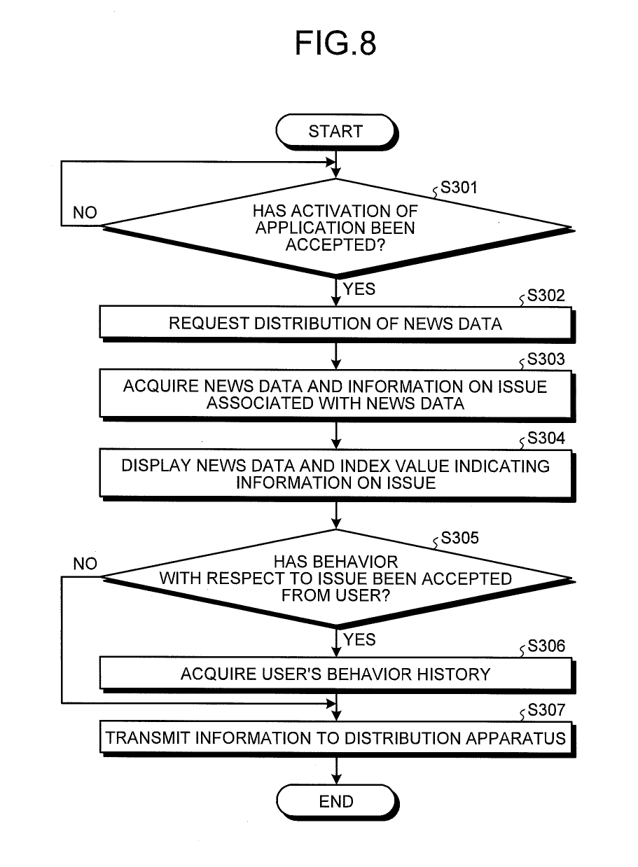

The flow of the information display process performed by the terminal device 10 according to the embodiment will be described below with reference to FIG. 8. FIG. 8 is a flowchart illustrating the flow of the information display process performed by the terminal device 10 according to the embodiment.

As illustrated in FIG. 8, the requesting unit 41 of the terminal device 10 determines whether activation of an application has been accepted from a user (Step S301). If the requesting unit 41 has not accepted activation of the application (NO at Step S301), the requesting unit 41 waits until activation is accepted.

In contrast, if the requesting unit 41 has accepted activation of the application (YES at Step S301), the requesting unit 41 requests the distribution apparatus 100 to distribute news data to be displayed according to operation of the application (Step S302).

Then, the accepting unit 42 acquires the news data distributed from the distribution apparatus 100 and information on an issue associated with the news data (Step S303). The display unit 43 displays an index value indicating the information on the issue associated with the news data, together with the news data (Step S304).

The accepting unit 42 determines whether a behavior with respect to the issue has been accepted from the user (Step S305). If the behavior with respect to the issue has not been accepted from the user (NO at Step S305), the accepting unit 42 does not acquire information on the user's behavior history or the like.

In contrast, if the behavior with respect to the issue has been accepted from the user (YES at Step S305), the accepting unit 42 acquires the user's behavior history with respect to the issue (Step S306). Then, the transmitting unit 44 transmits, to the distribution apparatus 100, information on viewing of the news data displayed by the display unit 43 in accordance with operation by the user, or information on the user's behavior history acquired by the accepting unit 42 (Step S307).

In the flowchart illustrated in FIG. 8, the accepting unit 42 may acquire information displayed by the display unit 43, such as chart information on a current price or a price movement of an issue to be displayed, at any step. For example, the accepting unit 42 may acquire latest information on the issue at the timing of switching a screen displayed on the application by the display unit 43.

5. Modification

The distribution apparatus 100 according to the above-described embodiment may be embodied in various forms other than the above-described embodiment. Other embodiments of the distribution apparatus 100 will be described below.

5-1. Behavior of User

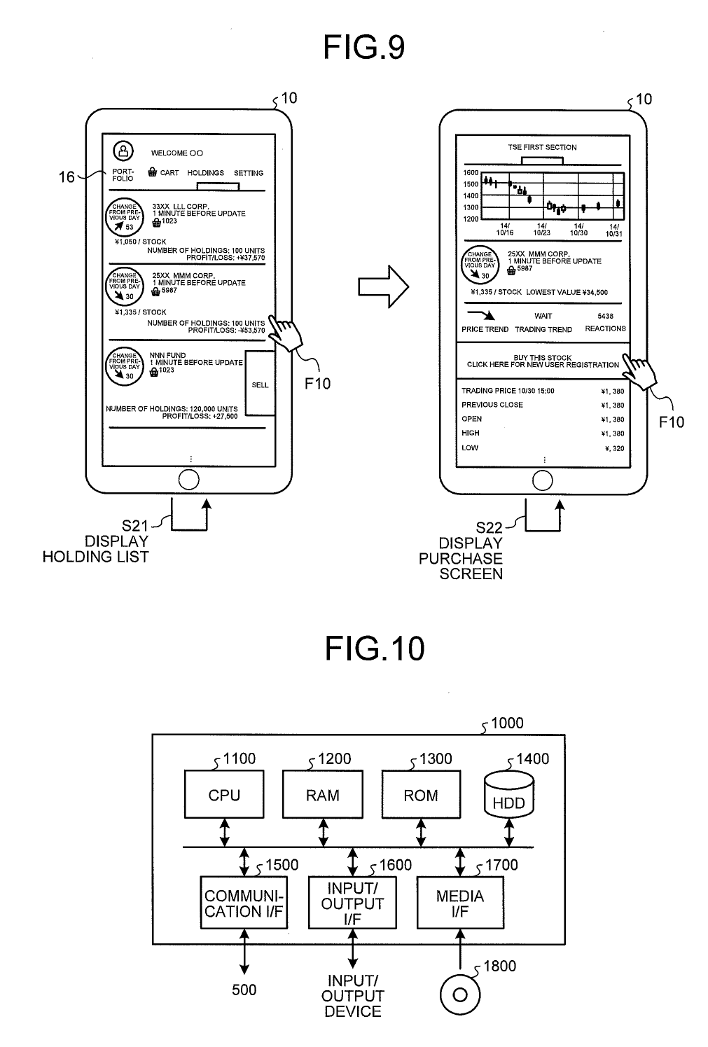

In the above-described embodiment, an example has been described in which an index value related to the investment information, such as the investment information displays M01 to M03, as illustrated in FIG. 1 is represented by the number of users who have registered an issue in the watch list. However, the above-described index value may be represented by other behaviors of users, rather than the behavior of registering the issue in the watch list. This will be described below with reference to FIG. 9.

FIG. 9 is a diagram illustrating an example of an information display process according to a modification. As illustrated in FIG. 9, the terminal device 10 displays, in an information display application, a holding list related to issues for each user (Step S21). In the example illustrated in FIG. 9, the user “∘∘” holds “LLL, MMM, NNN” as holding issues. In the screen illustrated in FIG. 9, the user can display an area, in which sale of a holding issue is selectable, by scrolling the screen in the horizontal direction. For example, in FIG. 9, the user can sell the holding issue “NNN” by clicking a “sell” button displayed on the right side of the issue “NNN”.

Furthermore, the user can display details of each issue or a screen for purchasing each issue, by clicking an area in which each issue is displayed. For example, the terminal device 10 displays a purchase screen for the issue “MMM” when an area displaying the issue “MMM” is clicked by the user with the finger F10 (Step S22).

In the purchase screen for the issue “MMM”, as illustrated in FIG. 9, issue information, such as a price movement chart of the issue “MMM”, a current trading price, a closing price of the previous day, or an opening price of today, is displayed. Furthermore, in the purchase screen for the issue “MMM”, information on behaviors of users with respect to the issue “MMM” is displayed. For example, in FIG. 9, an example is illustrated in which a trading trend of all of users indicates a “wait” trend for the issue “MMM”, and the number of reactions in an SNS service or the like is displayed. In this screen, the user can purchase the issue “MMM” by clicking a button of “purchase this stock”. The terminal device 10 may acquire information on a trading trend of all of the users or variation in the number of holdings of issues by the user during a predetermined period, in addition to information on actual purchase and sale. Then, the terminal device 10 appropriately transmits the acquired information to the distribution apparatus 100. The distribution apparatus 100 updates news data or user information based on the information transmitted from the terminal device 10.

As described above, the terminal device 10 acquires, as behaviors of users, not only information on behaviors of registering an issue in the watch list but also information on behaviors of actually purchasing or selling an investment product. In other words, the distribution unit 134 of the distribution apparatus 100 distributes, as information on behaviors of users with respect to the investment information associated with the news data, information on at least any of the number of users' purchases and sales of an issue contained in the investment information associated with the news data, a trading trend in purchasing and selling the issue, and variation in the number of holdings of issues during a predetermined period. Consequently, for example, the terminal device 10 can display, as the investment information displays M01 to M03, not only information on the number of users who have registered an issue in the watch list, but also the number of users who have actually purchased or sold an investment product. Therefore, with the distribution apparatus 100 that distributes information on behaviors of users, a user can recognize investment statuses of other users in line with current events. That is, the user can acquire an actual trading status as the investment information, in addition to the degree of attention indicating interests or concerns of other users with respect to the issue associated with the news data. Therefore, the user can take an aggressive action on investment. Consequently, the distribution apparatus 100 and the terminal device 10 can promote the investment behavior of the user.

5-2. Example of Index Value

The terminal device 10 can display an index value related to the investment information based on information different from the number of users who have registered an issue in the watch list or trading results on actual purchases and sales of an issue by users.

For example, the terminal device 10 acquires the number of users (UU number) who have viewed predetermined news data. The terminal device 10 acquires the number of users who have registered an issue associated with the news data in the watch list among the number of UUs who have viewed the news data. Then, the terminal device 10 may employ, as the investment information display, a value obtained by dividing the number of users who have registered the issue in the watch list by the number of UUs who have viewed the news data.

Accordingly, the user can obtain information on how many users have viewed certain news and how many users among these users have registered an issue related to the news in the watch list. Consequently, the user can more precisely analyze the degree of attention or an investment trend of the users such that even when all of the users pay great attention to the news, the users are not much interested in the issue related to the news.

Furthermore, as for the information as described above, the terminal device 10 may employ a combination of various types of information as the index value. For example, the terminal device 10 may display a ratio between the number of UUs who have viewed news and the number of users who have actually traded an issue associated with the news, or may display an index value using a ratio between the number of PVs of news and the number of users who have actually traded an issue associated with the news. Furthermore, the terminal device 10 may use the number of users by narrowing down the users by an attribute. For example, the terminal device 10 may calculate the number of users by narrowing down the users by age, gender, annual income, or the like, and may display the index value based on the calculated value. Accordingly, the user can more precisely obtain a trend of other users related to investment. Incidentally, the index value displayed by the terminal device 10 as described above may be distributed from the distribution unit 134 of the distribution apparatus 100. In this case, the distribution unit 134 distributes, to the terminal device 10, an index value generated from information on other users corresponding to an attribute of the user of the terminal device 10. In other words, the distribution unit 134 can generate an index value corresponding to the investment information by using data on users who have the similar attributes as that of the user using the terminal device 10, in accordance with the attribute of the user of the terminal device 10 (for example, age, gender, resident area, annual income, or the like among user attributes obtained through user authentication at the time of login to the application). Therefore, the user can refer to investment behaviors of users who have similar attributes as that of the user, and therefore can obtain a useful index for an investment behavior. Furthermore, the distribution apparatus 100 can cause an application to display information according to the attribute of the user, so that the application can be personalized according to the user. Therefore, the distribution apparatus 100 and the terminal device 10 can improve the usability for the user who views the investment information.

Moreover, the terminal device 10 may determine whether the user is allowed to actually perform trades, and use the determination to calculate the index value as described above. For example, users using the application include a user who has not opened an account for investment and is not able to perform actual trades. Therefore, the terminal device 10 may count the number of users who are able to perform actual trades and have registered an issue in the watch list. In this case, the user can obtain an investment trend of other users according to actual conditions. As described above, according to the distribution apparatus 100 and the terminal device 10, it is possible to ensure the usability of the index value indicating the degree of attention of users with respect to an issue related to news.

Furthermore, when calculating and displaying the index value related to the investment information, the terminal device 10 may add, as a calculation element, an investment experience or the like of a user whose information has been acquired. For example, a behavior of registration in the watch list by a user who has many investment experiences or a user who is recognized as an investment expert may be treated as weighted data relative to behaviors of registration in the watch list by other users. Moreover, as for an issue that is registered in the watch list by a relatively large number of users who have many investment experiences or by users who are recognized as investment experts during a predetermined period, the terminal device 10 may indicate a timing to purchase or sell the investment product by recommendation display or the like. Furthermore, when indicating the timing to purchase or sell an investment product, the terminal device 10 may determine the number of registrations in the watch list at the time of displaying the purchase timing or the sale timing, determine whether the information indicating the purchase timing or the sale timing is found accurate, and perform predetermined machine learning, in order to improve the accuracy of the investment information display including information indicating the timing to purchase or sell an investment product.

In the above-described embodiment, an example has been described in which the terminal device 10 displays the single investment information display M01 for the news data C01. However, the terminal device 10 may display a plurality of index values such as the investment information display M01 for a single piece of the news data C01. Furthermore, while an example has been described in the embodiment such that the terminal device 10 displays the index value, the index value as described above may be an index value distributed from the distribution unit 134 of the distribution apparatus 100, or may be generated on the terminal device 10 side.

5-3. Extraction of Investment Information

In the above-described embodiment, an example has been described in which the distribution apparatus 100 extracts an issue related to news data based on the news data. However, extraction of an issue to be associated with the news data may be performed by a predetermined external apparatus. In this case, the distribution apparatus 100 acquires news data and information on an investment issue to be associated with the news data. Then, the distribution apparatus 100 distributes the acquired news data and the investment information, such as an issue, to the terminal device 10 in an associated manner.

5-4. Order of Distribution and Display

In the above-described embodiment, an example has been described in which the distribution apparatus 100 distributes news data in accordance with a request from the terminal device 10. The distribution apparatus 100 may distribute the news data in a distribution order personalized by the user using the terminal device 10.

For example, the distribution unit 134 of the distribution apparatus 100 may distribute, to the terminal device 10, news data with a greater amount of information on behaviors of users with respect to investment information associated with the news data, as news data to be preferentially displayed on the terminal device 10. Therefore, news related to an issue for which investment behaviors are actively performed is preferentially distributed, so that it becomes possible to promote the investment behavior of the user. Furthermore, the distribution apparatus 100 may accept, from the terminal device 10, a distribution request for news data together with a viewing trend of each user. Then, the distribution apparatus 100 preferentially distributes news data that is highly likely to be viewed (for example, news data of a specific genre). The above-described process may be performed by the display unit 43 of the terminal device 10. Specifically, the display unit 43 preferentially displays news data with a greater amount of information on behaviors of users with respect to investment information associated with the news data. For example, the terminal device 10 may preferentially display, in the initial screen of the application, news of a genre that is highly likely to be viewed by the user. As described above, the distribution apparatus 100 and the terminal device 10 can display information according to the viewing trend of the user or the like, so that it is possible to improve the usability for the user who requests display of information.

Moreover, as for display of news, the terminal device 10 may perform adjustment to preferentially display news related to an issue for which a large number of trades are actually performed in a short time even if the number of actual trades or the number of registrations in the watch list with respect to the issue are relatively small.

5-5. Acquisition of Information

In the above-described embodiment, an example has been described in which the distribution apparatus 100 acquires data on a behavior that a user viewing a news article has performed in response to investment information, such as an issue, associated with news data in an application that runs on the terminal device 10. However, the distribution apparatus 100 may acquire information on a behavior of a user who has viewed news by using the terminal device 10 in which the application is not installed.

For example, the distribution apparatus 100 may cooperate with a website using a predetermined news service, and may acquire a behavior of a user who has viewed news through the website. In this case, for example, it is assumed that the news viewed by the user is content provided by the same news data provider. That is, the distribution apparatus 100 may include, as an object of the information display process, a user who has viewed the same news even when the news is provided by a different medium or a different type of an application. Consequently, the distribution apparatus 100 may widely acquire behaviors of users, in addition to those of users who use a specific application that runs on the terminal device 10, and may use the behaviors to display the investment information. Therefore, the distribution apparatus 100 can provide more reliable user data to the terminal device 10.

5-6. Display of Information

In the above-described embodiment, an example has been described in which the terminal device 10 receives distribution of news data and information on behaviors of users with respect to investment information associated with the news data from the distribution apparatus 100, and displays the news and an index value of the investment information by using a predetermined application. However, the terminal device 10 need not always use the predetermined information display application when displaying information.

For example, the terminal device 10 may display the news and the index value of the investment information by using a web browser application or the like that is installed in advance. In this case, the terminal device 10 can realize the same operation as the information display application of the embodiment by accessing a distribution server that provides an information display service via the network and by executing a file written in HyperText Markup Language (HTML) or the like.

5-7. Example of Content

In the above-described embodiment, an example has been described in which the distribution apparatus 100 associates investment information with news data provided by a predetermined news data provider, and distributes the investment information and the news data to the terminal device 10. However, the content used by the distribution apparatus 100 and the terminal device 10 is not limited to the news data. For example, the distribution apparatus 100 and the terminal device 10 may associate the investment information with a predetermined video content, instead of the news data. The terminal device 10 may allow the user to view a video content and may provide the investment information associated with the video content. Furthermore, the content is not limited to the news data, such as the latest information or report on an event, but may be an expert's column related to the news for example.

Moreover, a user as a viewer of contents need not always view all of the distributed contents. For example, in content, an article or the like may be displayed in a processed manner or a video contained in the content may be unreproducible, depending on an information medium such as an application on which the content is displayed. Even in this case, when a user views a part of a distributed content and performs a behavior of registering an issue associated with the content in the watch list, the distribution apparatus 100 may count the behavior of the user for use as an element of the index value indicating the investment information.

6. Others

Of the processes described in the embodiment, all or part of a process described as being performed automatically may also be performed manually. Alternatively, all or part of a process described as being performed manually may also be performed automatically by known methods. In addition, the processing procedures, specific names, and information including various types of data and parameters illustrated in the above-described document and drawings may be arbitrarily changed unless otherwise specified.

The components of apparatuses illustrated in the drawings are functionally conceptual and need not necessarily be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

For example, the news data storage unit 121 and the user information storage unit 122 illustrated in FIG. 2 may be stored in an external storage server or the like, without being stored in the distribution apparatus 100. In this case, the distribution apparatus 100 accesses the storage server to acquire news data, user information, and the like.

Furthermore, for example, the distribution apparatus 100 as described above may be distributed into a front end server side that mainly performs operation with external apparatuses to acquire news data or to accept user information from the terminal device 10, and a back end server side that performs an extraction process of extracting an issue or the like. Moreover, the process described as being executed by the distribution apparatus 100 may be executed by the terminal device 10. For example, the terminal device 10 may generate the index value in accordance with distributed information on behaviors of users, instead of receiving the index value for evaluating the investment information from the distribution apparatus 100, and may display the generated index value together with the content.

7. Hardware Configuration

The terminal device 10 according to the embodiment as described above is implemented by, for example, a computer 1000 with a configuration as illustrated in FIG. 10. FIG. 10 is a diagram illustrating an example of a hardware configuration of the computer 1000 that implements the functions of the terminal device 10. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates based on a program stored in the ROM 1300 or the HDD 1400, and controls each of units. The ROM 1300 stores therein a boot program executed by the CPU 1100 when the computer 1000 is activated, a program dependent on the hardware of the computer 1000, and the like.

The HDD 1400 stores therein a program executed by the CPU 1100, data used by the program, and the like. The communication interface 1500 receives data from other devices via a communication network 500, sends the data to the CPU 1100, and transmits data generated by the CPU 1100 to other devices via the communication network 500.

The CPU 1100 controls an output device, such as a display or a printer, an input device, such as a keyboard or a mouse, and the like via the input/output interface 1600. The CPU 1100 acquires data from the input device via the input/output interface 1600. The CPU 1100 outputs generated data to the output device via the input/output interface 1600.

The media interface 1700 reads a program or data stored in a recording medium 1800, and provides the program or the data to the CPU 1100 via the RAM 1200. The CPU 1100 loads the program onto the RAM 1200 from the recording medium 1800 via the media interface 1700, and executes the loaded program. The recording medium 1800 may be, for example, an optical recording medium such as a digital versatile disk (DVD) or a phase change rewritable disk (PD), magneto-optical recording medium such as a magneto-optical disk (MO), a tape medium, a magnetic recording medium, or a semiconductor memory.

For example, when the computer 1000 functions as the terminal device 10, the CPU 1100 of the computer 1000 executes the program loaded on the RAM 1200, and implements the functions of the control unit 40. Furthermore, the HDD 1400 stores therein data in the storage unit 60. While the CPU 1100 of the computer 1000 reads the program from the recording medium 1800 and executes the program, the program may be acquired from other devices via the communication network 500 as another embodiment.

8. Advantageous Effects

As described above, the distribution apparatus 100 according to the embodiment includes the accepting unit 133 and the distribution unit 134. The accepting unit 133 accepts, from the terminal device 10, a distribution request for news data (an example of content). The distribution unit 134 distributes, to the terminal device 10, news data associated with investment information, and information that is to be displayed on the terminal device 10 together with the news data and that indicates behaviors of users as viewers of communication information (a news article, a news related video, or the like when the content is news data) conveyed by the news data, in accordance with the distribution request accepted by the accepting unit 133.

In this manner, the distribution apparatus 100 according to the embodiment allows a user using an application to view the news article and to obtain an issue related to the news article. Furthermore, the user can recognize reactions of other users against the issue related to the news article that the user is viewing. Therefore, for example, even a user who is unfamiliar with investment or a beginner in investment can recognize an issue related to news or an investment trend of the issue by viewing the news article. Moreover, in general, news has high topicality, so that the user can obtain an index to determine a timing, such as a timing to purchase or sell an issue, by obtaining the investment trend of the issue together with the news. Consequently, according to the distribution apparatus 100 of the embodiment, it is possible to promote the investment behavior of the user.

Furthermore, the distribution unit 134 distributes, as the information to be displayed on the terminal device 10 together with the news data, an index value that is generated from information on behaviors of users with respect to the investment information associated with the news data and that is used to evaluate the investment information associated with the news data, to the terminal device 10.

Therefore, the distribution apparatus 100 according to the embodiment can display an evaluation of the investment information related to the news article, together with the news article or the like, on the terminal device 10. Consequently, when the user checks a headline or the like of a news article, the user can simultaneously check the degree of attention of users to the issue related to the news article and variation in the degree of attention of the users. As a result, according to the distribution apparatus 100, it is possible to smoothly provide the investment information to the user, enabling to activate the investment behavior of the user.

Moreover, the distribution unit 134 distributes, as the index value, an index value represented by a ratio between the number of pieces of information on behaviors of users with respect to the investment information associated with the news data and the number of unique users who have viewed the communication information, such as a news article, contained in the news data, to the terminal device 10.

Therefore, the distribution apparatus 100 according to the embodiment can display, on the terminal device 10, the number of behaviors of users relative to the number of all of users, as an evaluation value of the investment issue related to the news article. By employing, as an element of the index value, the number of unique users rather than the number of PVs of the news article, the distribution apparatus 100 can take a preventive action against a malicious user who intentionally increases the degree of attention of users with respect to a certain issue for example. Therefore, the distribution apparatus 100 can provide an appropriate index value related to the investment information to the user.

Furthermore, the distribution unit 134 distributes, to the terminal device 10, an index value generated from information on other users corresponding to an attribute of the user of the terminal device 10.

As described above, the distribution apparatus 100 according to the embodiment can generate the index value corresponding to the investment information by using data on users who have similar attributes as that of the user using the terminal device 10, in accordance with the attribute of the user of the terminal device 10 (for example, age, gender, resident area, annual income, or the like among user attributes obtained through user authentication at the time of login to the application). Therefore, the user can refer to investment behaviors of users who have similar attributes as that of the user, and therefore can obtain a useful index for an investment behavior. Furthermore, the distribution apparatus 100 can cause an application to display information according to the attribute of the user, so that the application can be personalized according to the user. Therefore, according to the distribution apparatus 100 or the terminal device 10, it is possible to improve the usability for the user who views the investment information.

Moreover, the distribution unit 134 distributes, as information on behaviors of users with respect to the investment information associated with the news data, at least one of information on inclusion of an issue, contained in the investment information associated with the news data, to a candidate trade object by the users, and information on exclusion of the issue from candidate trade objects by the users.

Therefore, the distribution apparatus 100 according to the embodiment can provide a specific index value on how much attention is given to the issue related to the viewed news by users who have viewed the news. Consequently, according to the distribution apparatus 100, it is possible to provide an appropriate index value with respect to the investment information.

Furthermore, the distribution unit 134 distributes, as information on behaviors of users with respect to the investment information associated with the news data, information on at least one of the number of unique users who have viewed the communication information, such as a news article, contained in the news data during a predetermined period, the number of views of the news article during a predetermined period, a value of a change in the number of the users during a predetermined period, the number of reactions of the users against the investment information associated with the news article or the news data, the number of viewers of a news article related to the predetermined news article, and an average viewing time of the news article by the users.

As described above, the distribution apparatus 100 according to the embodiment can employ a viewing behavior of users as an element to determine the evaluation of the investment information associated with the news. Therefore, a user can obtain a trend of users as to what kind of news is interested in by other users and the degree of possibility that the interest may result in an investment behavior. As described above, according to the distribution apparatus 100, not only simple information on a price movement of an investment issue, but also information on behaviors of users can be employed as the information on the investment issue. Therefore, it is possible to widely provide information on a factor for determination of investment by the user.

Moreover, the distribution unit 134 distributes, as information on behaviors of users with respect to the investment information associated with the news data, information on at least one of the number of purchases and sales of an issue by the users, a trading trend of users in purchasing and selling the issue, and variation in the number of holdings of issues during a predetermined period.

As described above, the distribution apparatus 100 according to the embodiment can distribute information on behaviors, such as actual purchases and sales of the issue by the users. Therefore, for example, a user can easily obtain information, such as information indicating that users who have viewed predetermined news are actively doing purchases, as information to be referred to for own investment. Therefore, the distribution apparatus 100 can promote the investment behavior of the user.

Furthermore, the distribution unit 134 distributes, to the terminal device 10, news data with a greater amount of information on behaviors with respect to the investment information associated with the news data, as news data to be preferentially displayed on the terminal device 10.

As described above, the distribution apparatus 100 according to the embodiment can adjust the order of display of news data in accordance with behaviors of users. Therefore, for example, the distribution apparatus 100 can flexibly take an action so that the user can obtain useful information, by preferentially providing the user with news data with which users are actively performing investment behaviors during a predetermined period. In this case, the display unit 43 of the terminal device 10 may display a news article to the user based on the order of news data distributed from the distribution apparatus 100. Therefore, the user can easily recognize a trading trend of an issue associated with the distributed news article in the current market. Furthermore, the distribution apparatus 100 and the terminal device 10 according to the embodiment can improve the usability for the user by adjusting the order of display of useful information. Consequently, the distribution apparatus 100 provides the user with information useful for an investment issue, so that it is possible to promote the investment behavior of the user.

Moreover, the terminal device 10 according to the embodiment (an example of an information display apparatus) includes the accepting unit 42 that accepts news data distributed from the distribution apparatus 100, and the display unit 43 that displays the news data accepted by the accepting unit 42 and information on behaviors of users as viewers of communication information, such as a news article or a news image, contained in the news data with respect to the investment information.

As described above, the terminal device 10 according to the embodiment displays the distributed news article and the behaviors of users with respect to the investment information associated with the news article. Specifically, with the information displayed by the terminal device 10, a user can view a news article and simultaneously obtain behaviors of users with respect to an issue associated with the news article. In this manner, the terminal device 10 displays information on investment together with content, such as a news article, that is normally viewed by a user, so that it is possible to increase the interest or concern of the user in the investment behavior, and to provide useful investment information even to a user who has less opportunities to obtain finance information or the like. Consequently, the terminal device 10 according to the embodiment can promote the investment behavior of the user.

While the embodiments of the present invention have been described above in detail, these embodiments are mere examples, and the present invention may be embodied in various different forms including modifications, other than the above-described embodiments.

Furthermore, the distribution apparatus 100 may be implemented by multiple server computers. In addition, the structure may be changed flexibly depending on functions. The functions may be implemented by calling an external platform or the like by an application programming interface (API) or network computing.

Moreover, “a unit” recited in the claims may be replaced with “a section, a module, or a means” or “a circuit”. For example, the distribution unit may be replaced with a distributing means or a distribution circuit.

According to an embodiment, it is possible to promote an investment behavior of a user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A distribution apparatus comprising:
an accepting unit that accepts, from a terminal device, a distribution request for content; and
a distribution unit that distributes, to the terminal device, the content associated with investment information, and information that is to be displayed on the terminal device together with the content and that indicates behaviors of viewers of information conveyed by the content with respect to the investment information, in accordance with the distribution request accepted by the accepting unit.

2. The distribution apparatus according to claim 1, wherein the distribution unit distributes, as the information to be displayed on the terminal device together with the content, an index value that is generated from information on behaviors of the viewers with respect to the investment information and that is used to evaluate the investment information, to the terminal device.

3. The distribution apparatus according to claim 2, wherein the distribution unit distributes, as the index value, an index value represented by a ratio between number of pieces of information on behaviors of the viewers with respect to the investment information and number of the viewers, to the terminal device.

4. The distribution apparatus according to claim 2, wherein the distribution unit distributes, to the terminal device, an index value generated from information on viewers corresponding to an attribute of a user of the terminal device among the viewers.

5. The distribution apparatus according to claim 1, wherein the distribution unit distributes, as information on behaviors of the viewers with respect to the investment information, at least one of information on inclusion of an issue, contained in the investment information associated with the content, to a candidate trade object by the viewers, and information on exclusion of the issue from candidate trade objects by the viewers.

6. The distribution apparatus according to claim 1, wherein the distribution unit distributes, as information on behaviors of the viewers with respect to the investment information, information on at least one of number of the viewers during a predetermined period, number of views of the content during a predetermined period, a value of a change in number of the viewers during a predetermined period, number of reactions of the viewers against the content or the investment information associated with the content, number of viewers of content related to the content, and an average viewing time of the viewers.

7. The distribution apparatus according to claim 1, wherein the distribution unit distributes, as information on behaviors of the viewers with respect to the investment information, information on at least one of number of purchases and sales of an issue contained in investment information associated with the content by the viewers, a trading trend of the viewers in purchasing and selling the issue, and variation in the number of holdings of issues in a predetermined period.

8. The distribution apparatus according to claim 1, wherein the distribution unit distributes, to the terminal device, content with a greater amount of information on behaviors with respect to the investment information, as content to be preferentially displayed on the terminal device.

9. A distribution method implemented by a computer, comprising:
accepting, from a terminal device, a distribution request for content; and
distributing, to the terminal device, the content associated with investment information, and information that is to be displayed on the terminal device together with the content and that indicates behaviors of viewers of information conveyed by the content with respect to the investment information, in accordance with the distribution request accepted at the accepting.

10. A non-transitory computer readable storage medium having stored therein an information display program, the information display program causing a computer to execute:
accepting content distributed from a distribution apparatus, the content being associated with investment information; and
displaying the content accepted at the accepting and information on behaviors of viewers of information conveyed by the content with respect to the investment information.
